(19) United States
(12) Patent Application Publication
(10) Pub. No.: US 2015/0084588 A1
(43) Pub. Date: Mar. 26, 2015

(54) WIRING HARNESS AND WIRELESS POWER TRANSFER SYSTEM

(71) Applicant: Auckland UniServices Ltd., Auckland (NZ)

(72) Inventors: Grant Anthony Covic, Mount Albert (NZ); John Talbot Boys, Albany (NZ); Edward van Boheemen, Panmure (NZ); Michael Le Gallais Kissin, Takapuna (NZ); Nicholas Athol Keeling, Glenfield (NZ); Jonathan Beaver, Mount Wellington (NZ)

(21) Appl. No.: 14/386,206

(22) PCT Filed: Mar. 20, 2013
(86) PCT No.: PCT/NZ2013/000045

§ 371 Date: Sep. 18, 2014

Related U.S. Application Data
(60) Provisional application No. 61/613,414, filed on Mar. 20, 2012.

(51) Int. Cl. B60R 16/02; H02G 3/04; H02J 5/00; H02J 7/02; B60L 11/18; H02J 17/00

(52) U.S. Cl. CPC B60R 16/0207; B60L 11/182; H02J 17/00; H02J 5/005; H02J 7/025; H02G 3/0406
USPC 320/108; 307/104; 29/860; 174/72 A

(57) ABSTRACT

This disclosure provides methods and apparatus for use in wireless power transfer and particularly wireless power transfer to remote system such as electric vehicles. In one aspect a wireless power transfer system comprises a wireless power transfer device comprising a first connector portion; an electrical device comprising a second connector portion; and a wiring harness comprising a cable, a first end connector portion at one end of the cable configured to be removably connected to the first connector portion, and a second end connector portion at the other end of the second connector portion. In another aspect the the cable configured to be removably connected to wiring harness comprises a plurality of cables, each comprising a plurality of conductive filaments; and a connector portion comprising a plurality of pins each comprising a recessed end, wherein an end of each cable is soldered into the respective recessed ends.

### FIELD OF THE INVENTION

The technical field relates generally to wireless power transfer, and more specifically to devices, systems, and methods related to wireless power transfer to remote systems such as vehicles including batteries. In particular, the technical field relates to arrangements for a wiring harness used in wireless power transfer systems, and more particularly inductive power transfer (IPT) systems.

### BACKGROUND

Remote systems, such as vehicles, have been introduced that include locomotion power derived from electricity received from an energy storage device such as a battery. For example, hybrid electric vehicles include on-board chargers that use power from vehicle braking and traditional motors to charge the vehicles. Vehicles that are solely electric generally receive the electricity for charging the batteries from other sources. Battery electric vehicles (electric vehicles) are often proposed to be charged through some type of wired alternating current (AC) such as household or commercial AC supply sources. The wired charging connections require cables or other similar connectors that are physically connected to a power supply. Cables and similar connectors may sometimes be inconvenient or cumbersome and have other drawbacks. Wireless charging systems that are capable of transferring power in free space (e.g., via a wireless field) to be used to charge electric vehicles may overcome some of the deficiencies of wired charging solutions. As such, wireless charging systems and methods that efficiently and safely transfer power for charging electric vehicles are desirable.

Wireless power transfer systems may utilize inductive power transfer (IPT) to transfer power between base and pickup power devices. The base and pickup devices typically form part of respective base and pickup systems, with separate components performing functions such as power supply or charging of batteries. It is generally desirable to physically separate these components in order to minimize their physical footprint to assist in installation at locations with limited space, or where minimal visual impact is desired.

To date, connection between components of the respective base and pickup sides has been achieved by providing a permanent physical interconnection in the form of hardwired cables between components during manufacture. This has been necessary due to the high frequency and power of the signals transmitted between the components, together with the nature of the cable required for such connections, in order to achieve the efficiency required of a power transfer system.

However, such an arrangement is not ideal in terms of manufacture, installation, or repair of the systems. It is generally desirable for each of the components of the wireless power transfer system to be manufactured and installed individually, and subsequently connected together as required.

It is an object of the disclosed embodiments to address at least one of the foregoing problems, or at least to provide the public with a useful choice.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a wireless power transfer system. The system can comprise a wireless power transfer device, which can comprise a first connector portion. The system can further comprise an electrical device, which can comprise a second connector portion. The system can comprise a wiring harness which can comprise a cable, and a first end connector portion at one end of the cable. The first end connector portion can be configured to be removably connected to the first connector portion. The wiring harness can comprise a second end connector portion at the other end of the cable. The second end connector portion can be configured to be removably connected to the second connector portion. The electrical device can comprise a battery charging system. The electrical device can comprise a power supply.

Another aspect relates to a wiring harness for a wireless power transfer system. The wiring harness can comprise a plurality of cables. Each cable can comprise a plurality of conductive filaments. The wiring harness can further comprise a first connector portion connected to a first end of the cables. The first connector portion can comprise a plurality of pins. Each pin can comprise a recessed end. An end of each of the cables can be soldered into the respective recessed ends. Each cable can comprise litz wire. Each pin can be rated for at least 23 Å(rms). Each pin can be rated for at least 830V(rms). Each pin can be made of copper. Each pin can comprise a cylindrical contact surface. The cylindrical contact surface can be at least substantially 4 mm in diameter. At least two of the cables can have a first designation, and at least two of the cables can have a second designation. The first connector portion can be configured to receive the pins such that the voltage isolation between the cables of the first designation and the second designation is greater than that between the cables of the same designation. The first connector portion can be configured to have no conductive loops between the pins.

Yet another aspect relates to a method of manufacturing a wiring harness for a wireless power transfer system. The method can comprise, for a plurality of cables each comprising a plurality of conductive filaments, soldering the respective conductive filaments together to form a plurality of terminated cables. The method can comprise inserting each terminated cable into a respective recessed end of a pin of a first connector portion. The method can comprise applying heat to each terminated cable such that the conductive filaments are soldered to the pins. Soldering the conductive filaments can comprise inserting the conductive filaments of the cable simultaneously into a solder pot. The temperature of the solder pot can be maintained within a range of substantially 350 degrees Celsius to substantially 500 degrees Celsius. The temperature of the solder pot can be maintained at substantially 450 degrees Celsius.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments can be employed and the described embodiments are intended to include all such aspects and their equivalents.

Further aspects of the invention, which should be considered in all its novel aspects, will become apparent from the following description.

### BRIEF DESCRIPTION OF THE DRAWINGS

FIG. 1 is a diagram of an exemplary wireless power transfer system for charging an electric vehicle, in accordance with an exemplary embodiment of the invention.

FIG. 2 is a schematic diagram of exemplary core components of the wireless power transfer system of FIG. 1.

FIG. 3 is an illustration of a subset of a wireless power transfer system, in accordance with an exemplary embodiment of the invention.

FIG. 4 is an illustration of a connection between a wiring harness and a wireless power transfer device, in accordance with an exemplary embodiment of the invention.

FIG. 5 is an illustration of a connection between a cable and a pin, in accordance with exemplary embodiments of the invention.

FIG. 6 is a flow chart of an exemplary method for manufacturing a wiring harness, in accordance with exemplary embodiments of the invention.

FIG. 7 is an illustration of an insert for use in a connector of a wiring harness, in accordance with an exemplary embodiment of the invention.

FIG. 8 is an illustration of a connector, in accordance with an exemplary embodiment of the invention.

The various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

The detailed description set forth below in connection with the appended drawings is intended as a description of exemplary embodiments of the invention and is not intended to represent the only embodiments in which the invention may be practiced. The term “exemplary” used throughout this description means “serving as an example, instance, or illustration,” and should not necessarily be construed as preferred or advantageous over any other embodiments. The detailed description includes specific details for the purpose of providing a thorough understanding of the exemplary embodiments of the invention. In some instances, some devices are shown in block diagram form.

Wirelessly transferring power may refer to transferring any form of energy associated with electric fields, magnetic fields, electromagnetic fields, or otherwise from a transmitter to a receiver without the use of physical electrical conductors (e.g., power may be transferred through free space). The power output into a wireless field (e.g., a magnetic field) may be received, captured by, or coupled by a “receiving coil” to achieve power transfer.

An electric vehicle is used herein to describe a remote system, an example of which is a vehicle that includes, as part of its locomotion capabilities, electrical power derived from a chargeable energy storage device (e.g., one or more rechargeable electrochemical cells or other type of battery). As non-limiting examples, some electric vehicles may be hybrid electric vehicles that include besides electric motors, a traditional combustion engine for direct locomotion or to charge the vehicle's battery. Other electric vehicles may draw all locomotion ability from electrical power. An electric vehicle is not limited to an automobile and may include motorcycles, carts, scooters, and the like. By way of example and not limitation, a remote system is described herein in the form of an electric vehicle (EV). Furthermore, other remote systems that may be at least partially powered using a chargeable energy storage device are also contemplated (e.g., electronic devices such as personal computing devices and the like).

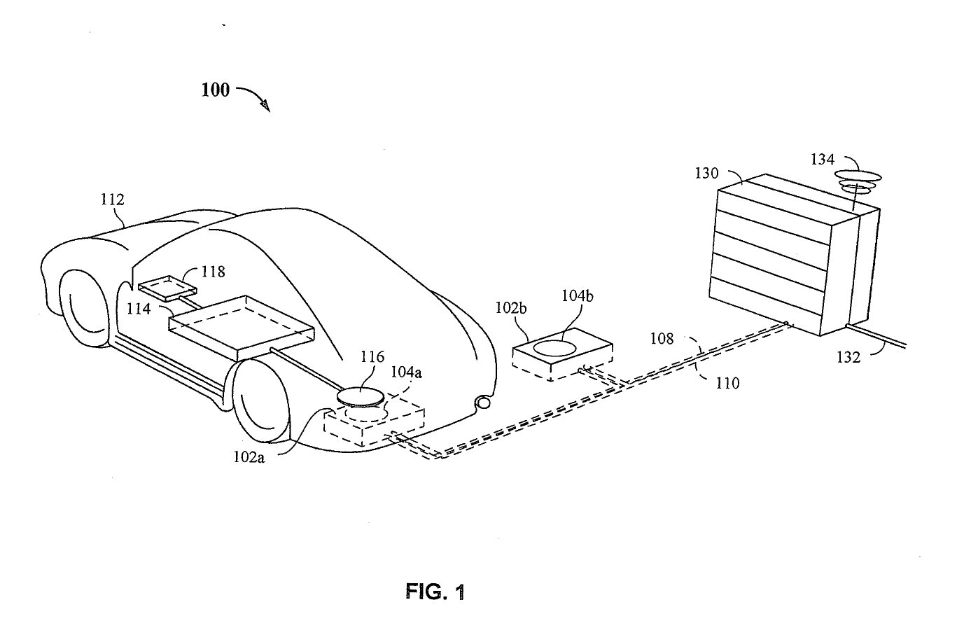

FIG. 1 is a diagram of an exemplary wireless power transfer system 100 for charging an electric vehicle 112, in accordance with an exemplary embodiment of the invention. The wireless power transfer system 100 enables charging of an electric vehicle 112 while the electric vehicle 112 is parked near a base wireless charging system 102a. Spaces for two electric vehicles are illustrated in a parking area to be parked over corresponding base wireless charging system 102a and 102b. In some embodiments, a local distribution center 130 may be connected to a power backbone 132 and configured to provide an alternating current (AC) or a direct current (DC) supply through a power link 110 to the base wireless charging system 102a. The base wireless charging system 102a also includes a base system induction coil 104a for wirelessly transferring or receiving power. An electric vehicle 112 may include a battery unit 118, an electric vehicle induction coil 116, and an electric vehicle wireless charging system 114. The electric vehicle induction coil 116 may interact with the base system induction coil 104a for example, via a region of the electromagnetic field generated by the base system induction coil 104a.

In some exemplary embodiments, the electric vehicle induction coil 116 may receive power when the electric vehicle induction coil 116 is located in an energy field produced by the base system induction coil 104a. The field corresponds to a region where energy output by the base system induction coil 104a may be captured by an electric vehicle induction coil 116. In some cases, the field may correspond to the “near field” of the base system induction coil 104a. The near-field may correspond to a region in which there are strong reactive fields resulting from the currents and charges in the base system induction coil 104a that do not radiate power away from the base system induction coil 104a. In some cases the near-field may correspond to a region that is within about ½π of the wavelength of the base system induction coil 104a (and vice versa for the electric vehicle induction coil 116) as will be further described below.

Local distribution 130 may be configured to communicate with external sources (e.g., a power grid) via a communication backhaul 134, and with the base wireless charging system 102a via a communication link 108.

In some embodiments the electric vehicle induction coil 116 may be aligned with the base system induction coil 104a and, therefore, disposed within a near-field region simply by the driver properly aligning the electric vehicle 112 relative to the base system induction coil 104a. In other embodiments, the driver may be given visual feedback, auditory feedback, or combinations thereof to determine when the electric vehicle 112 is properly placed for wireless power transfer. In yet other embodiments, the electric vehicle 112 may be positioned by an autopilot system, which may move the electric vehicle 112 back and forth (e.g., in zig-zag movements) until an alignment error has reached a tolerable value. This may be performed automatically and autonomously by the electric vehicle 112 without or with only minimal driver intervention provided that the electric vehicle 112 is equipped with a servo steering wheel, ultrasonic sensors, and intelligence to adjust the vehicle. In still other embodiments, the electric vehicle induction coil 116, the base system induction coil 104a, or a combination thereof may have functionality for displacing and moving the induction coils 116 and 104a relative to each other to more accurately orient them and develop more efficient coupling therebetween.

The base wireless charging system 102a may be located in a variety of locations. As non-limiting examples, some suitable locations include a parking area at a home of the electric vehicle 112 owner, parking areas reserved for electric vehicle wireless charging modeled after petroleum-based filling stations, and parking lots at other locations such as shopping centers and places of employment.

Charging electric vehicles wirelessly may provide numerous benefits. For example, charging may be performed automatically, virtually without driver intervention and manipulations thereby improving convenience to a user. There may also be no exposed electrical contacts and no mechanical wear out, thereby improving reliability of the wireless power transfer system 100. Further, since an electric vehicle 112 may be used as distributed storage devices to stabilize a power grid, a docking-to-grid solution may be used to increase availability of vehicles for Vehicle-to-Grid (V2G) operation.

A wireless power transfer system 100 as described with reference to FIG. 1 may also provide aesthetical and non-impedimental advantages. For example, there may be no charge columns and cables that may be impedimental for vehicles and/or pedestrians.

As a further explanation of the vehicle-to-grid capability, the wireless power transmit and receive capabilities may be configured to be reciprocal such that the base wireless charging system 102a is capable of transferring power to the electric vehicle 112 and the electric vehicle 112 is also capable of transferring power to the base wireless charging system 102a e.g., in times of energy shortfall in power backbone 132. This capability may be useful to stabilize the power distribution grid by allowing electric vehicles to contribute power to the overall distribution system in times of energy shortfall caused by over demand or shortfall in variable or renewable energy production (e.g., wind or solar).

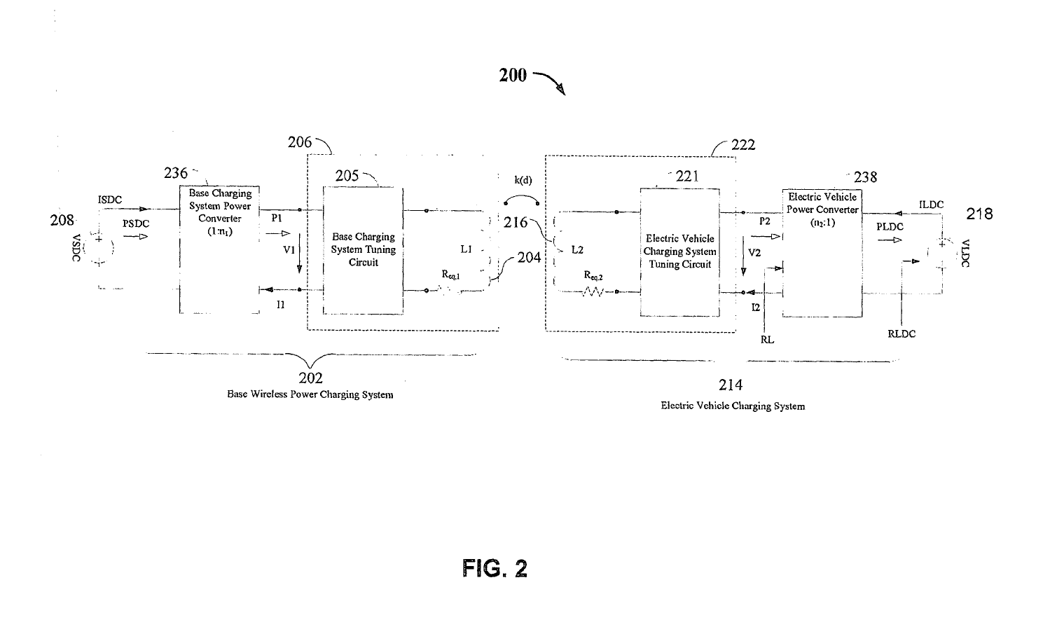

FIG. 2 is a schematic diagram of exemplary core components of the wireless power transfer system 100 of FIG. 1. As shown in FIG. 2, the wireless power transfer system 200 may include a base system transmit circuit 206 including a base system induction coil 204 having an inductance L₁. The wireless power transfer system 200 further includes an electric vehicle receive circuit 222 including an electric vehicle induction coil 216 having an inductance L₂. Embodiments described herein may use capacitively loaded wire loops (i.e., multi-turn coils) forming a resonant structure that is capable of efficiently coupling energy from a primary structure (transmitter) to a secondary structure (receiver) via a magnetic or electromagnetic near field if both primary and secondary are tuned to a common resonant frequency. The coils may be used for the electric vehicle induction coil 216 and the base system induction coil 204. Using resonant structures for coupling energy may be referred to as “magnetic coupled resonance,” “electromagnetic coupled resonance,” and/or “resonant induction.” The operation of the wireless power transfer system 200 will be described based on power transfer from a base wireless power charging system 202 to an electric vehicle 112, but is not limited thereto. For example, as discussed above, the electric vehicle 112 may transfer power to the base wireless charging system 102a.

With reference to FIG. 2, a power supply 208 (e.g., AC or DC) supplies power P_{SDC} to the base wireless power charging system 202 to transfer energy to an electric vehicle 112. The base wireless power charging system 202 includes a base charging system power converter 236. The base charging system power converter 236 may include circuitry such as an AC/DC converter configured to convert power from standard mains AC to DC power at a suitable voltage level, and a DC/low frequency (LF) converter configured to convert DC power to power at an operating frequency suitable for wireless high power transfer. The base charging system power converter 236 supplies power P₁ to the base system transmit circuit 206 including a base charging system tuning circuit 205 which may consist of reactive tuning components in a series or parallel configuration or a combination of both with the base system induction coil 204 to emit an electromagnetic field at a desired frequency. In one embodiment, a capacitor may be provided to form a resonant circuit with the base system induction coil 204 that resonates at a desired frequency.

The base system transmit circuit 206, including the base system induction coil 204, and electric vehicle receive circuit 222, including the electric vehicle induction coil 216, may be tuned to substantially the same frequencies and may be positioned within the near-field of an electromagnetic field transmitted by one of the base system induction coil 204 and the electric vehicle induction coil 116. In this case, the base system induction coil 204 and electric vehicle induction coil 216 may become coupled to one another such that power may be transferred to the electric vehicle receive circuit 222 including an electric vehicle charging system tuning circuit 221 and electric vehicle induction coil 216. The electric vehicle charging system tuning circuit 221 may be provided to form a resonant circuit with the electric vehicle induction coil 216 that resonates at a desired frequency. The mutual coupling coefficient resulting at coil separation is represented in the diagram by k(d). Equivalent resistances R_{eq,1} and R_{eq,2} represent the losses that may be inherent to the induction coils 204 and 216 and any anti-reactance capacitors that may, in some embodiments, be provided in the base charging system tuning circuit 205 and electric vehicle charging system tuning circuit 221 respectively. The electric vehicle receive circuit 222, including the electric vehicle induction coil 216 and electric vehicle charging system tuning circuit 221, receives power P₂ and provides the power P₂ to an electric vehicle power converter 238 of an electric vehicle charging system 214.

The electric vehicle power converter 238 may include, among other things, a LF/DC converter configured to convert power at an operating frequency back to DC power at a voltage level matched to the voltage level of an electric vehicle battery unit 218. The electric vehicle power converter 238 may provide the converted power P_{LDC} to charge the electric vehicle battery unit 218. The power supply 208, base charging system power converter 236, and base system induction coil 204 may be stationary and located at a variety of locations as discussed above. The battery unit 218, electric vehicle power converter 238, and electric vehicle induction coil 216 may be included in an electric vehicle charging system 214 that is part of electric vehicle 112 or part of the battery pack (not shown). The electric vehicle charging system 214 may also be configured to provide power wirelessly through the electric vehicle induction coil 216 to the base wireless power charging system 202 to feed power back to the grid. Each of the electric vehicle induction coil 216 and the base system induction coil 204 may act as transmit or receive induction coils based on the mode of operation.

Further, the electric vehicle charging system 214 may include switching circuitry (not shown) for selectively connecting and disconnecting the electric vehicle induction coil 216 to the electric vehicle power converter 238. Disconnecting the electric vehicle induction coil 216 may suspend charging and also may adjust the “load” as “seen” by the base wireless charging system 102a (acting as a transmitter), which may be used to decouple the electric vehicle charging system 214 (acting as the receiver) from the base wireless charging system 202. The load changes may be detected if the transmitter includes the load sensing circuit. Accordingly, the transmitter, such as a base wireless charging system 202, may have a mechanism for determining when receivers, such as an electric vehicle charging system 214, are present in the near-field of the base system induction coil 204.

As described above, in operation, assuming energy transfer towards the vehicle or battery, input power is provided from the power supply 208 such that the base system induction coil 204 generates a field for providing the energy transfer. The electric vehicle induction coil 216 couples to the radiated field and generates output power for storage or consumption by the electric vehicle 112. As described above, in some embodiments, the base system induction coil 204 and electric vehicle induction coil 216 are configured according to a mutual resonant relationship such that the resonant frequency of the electric vehicle induction coil 216 and the resonant frequency of the base system induction coil 204 are very close or substantially the same. Transmission losses between the base wireless power charging system 202 and electric vehicle charging system 214 are minimal when the electric vehicle induction coil 216 is located in the near-field of the base system induction coil 204.

As stated, an efficient energy transfer occurs by coupling a large portion of the energy in the near field of a transmitting induction coil to a receiving induction coil rather than propagating most of the energy in an electromagnetic wave to the far-field. When in the near field, a coupling mode may be established between the transmit induction coil and the receive induction coil. The area around the induction coils where this near field coupling may occur is referred to herein as a near field coupling mode region.

The electric vehicle induction coil 216 and base system induction coil 204 as described throughout the disclosed embodiments may be referred to or configured as “loop” antennas, and more specifically, multi-turn loop antennas. The induction coils 204 and 216 may also be referred to herein or be configured as “magnetic” antennas. The term “coils” is intended to refer to a component that may wirelessly output or receive energy for coupling to another “coil.” The coil may also be referred to as an “antenna” of a type that is configured to wirelessly output or receive power. Loop (e.g., multi-turn loop) antennas may be configured to include an air core or a physical core such as a ferrite core. An air core loop antenna may allow the placement of other components within the core area. Physical core antennas including ferromagnetic materials may allow development of a stronger electromagnetic field and improved coupling.

As discussed above, efficient transfer of energy between a transmitter and receiver occurs during matched or nearly matched resonance between a transmitter and a receiver. However, even when resonance between a transmitter and receiver are not matched, energy may be transferred at a lower efficiency. Transfer of energy occurs by coupling energy from the near field of the transmitting induction coil to the receiving induction coil residing within a region (e.g., within a predetermined frequency range of the resonant frequency, or within a predetermined distance of the near-field region) where this near field is established rather than propagating the energy from the transmitting induction coil into free space.

A resonant frequency may be based on the inductance and capacitance of a transmit circuit including an induction coil (e.g., the base system induction coil 204) as described above. As shown in FIG. 2, inductance may generally be the inductance of the induction coil, whereas capacitance may be added to the induction coil to create a resonant structure at a desired resonant frequency. As a non limiting example, as shown in FIG. 2, a capacitor may be added in series with the induction coil to create a resonant circuit (e.g., the base system transmit circuit 206) that generates an electromagnetic field, which may be referred to as a series-tuned resonant circuit. Accordingly, for larger diameter induction coils, the value of capacitance for inducing resonance may decrease as the diameter or inductance of the coil increases. Inductance may also depend on a number of turns of an induction coil. Furthermore, as the diameter of the induction coil increases, the efficient energy transfer area of the near field may increase. Other resonant circuits are possible. As another non limiting example, a capacitor may be placed in parallel between the two terminals of the induction coil (e.g., a parallel resonant circuit which may alternatively be referred to as a parallel-tuned resonant circuit). Furthermore an induction coil may be designed to have a high quality (Q) factor to improve the resonance of the induction coil.

The base wireless charging system 102a, base system transmit circuit 206, electric vehicle coil 116, and electric vehicle receive circuit 222 of FIG. 1 and FIG. 2 provide examples of what may herein individually be referred to generically as a wireless power transfer device, or more specifically an inductive power transfer device. As illustrated, particularly by FIG. 1, it is desirable to connect these to other electrical devices such as the local distribution centre 130, base charging power converter 236, electric vehicle wireless charging system 114, and electric power converter 236 respectively, which are preferably located remotely from the connected wireless power transfer device.

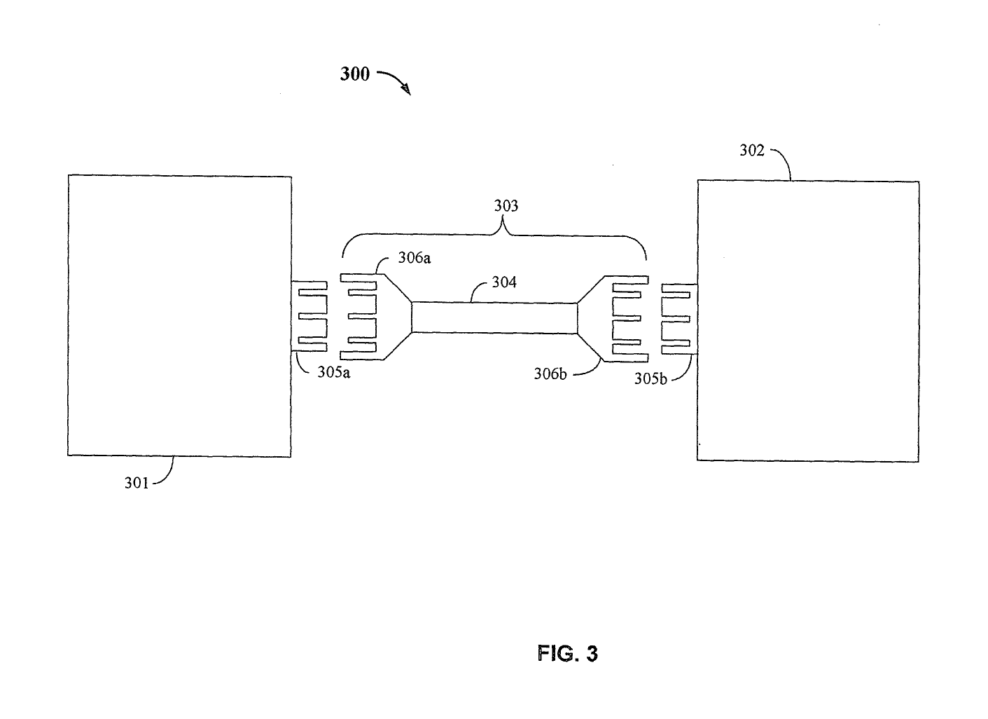

FIG. 3 is a diagram of a subset of an exemplary wireless power transfer system 300, in accordance with an exemplary embodiment of the invention. A wireless power transfer device in the form of a base wireless charging system 301 is connected to an electrical device in the form of a power supply 302 by a wiring harness 303 comprising a cable 304. Reference to a wiring harness should be understood to mean a collection of one or more conductive cables configured to interconnect electrical devices, typically modular devices, by way of removable connectors.

The base wireless charging system 301 and power supply 302 each include a socket 305a, 305b. A connector 306a, 306b is provided at each end of the cable 304, each configured to be received by the respective sockets 305a, 305b.

By configuring the components of the wireless power transfer system to be connectable, ease of manufacture may be improved, particularly with regard to installation in a vehicle or charging location. The components may be more readily maneuvered into position, without the risk of fouling hardwired cabling or being limited in movement by same, and subsequently connected with the wiring harness. This may be particularly important in a production line, where the speed of assembly may otherwise be limited by the complexity of components being permanently interconnected.

The removable connections also enable the individual components of the system to be more readily manufactured, removing the step of creating the permanent physical connection prior to installation. This may be particularly useful where components are manufactured in different facilities. Storage and transportation of the wireless power transfer system may also be simplified in comparison with one in which permanent physical connections are made. It may also assist in ongoing repair or replacement of individual components, which may be disconnected from the system without disturbing other components.

It should be appreciated that while the subset of an exemplary wireless power transfer system 300 is described with reference to the base side of the wider wireless power transfer system, the present invention may be applied to the electric vehicle or receiver side of the system.

In one embodiment the cabling used to connect the wireless power transfer device and other electrical device is litz wire. It is considered that litz wire is one of the more appropriate types of wire for use in high frequency alternating currents as used in the present invention. Litz wire consists of an insulating sheath containing many conductive filaments in the form of thin wire strands, each of which are individually insulated using a material such as enamel or polyurethane and then twisted or woven together. The multiple strands effectively negate the skin effect which can occur at high frequency by having many cores through which the current can travel.

In one embodiment the cables themselves may be interlaced in order to minimize the external field generated by the current passing through them. It should be appreciated that the pattern for this interlacing may be dependent on the number of cables used and the direction of current flow of said cables.

It should be appreciated that while it is envisaged that litz wire may be used according to some embodiments, alternative forms of electric wire may be used for the cable.

Litz wire presents some difficulties in terms of connection to a connector. Because each individual strand is individually insulated, it is difficult to create a conductive pathway between each strand and the connector in order to access the benefits of using litz wire to begin with. Crimp type connectors apply mechanical stress on wires to which they are applied. In the case of litz wire, the strands are relatively delicate, and susceptible to being damaged on being bent. In an environment susceptible to high levels of vibration, such as in a vehicle, crimping may create a weak point in the strands which fails due to minute bending over time caused by the vibrations. Further, such connectors may only contact outer strands, and rely on compression of the strands to create electrical connectivity with inner strands. As well as creating air gaps between the strands, this reliance on a strand to strand interface may result in a lower degree of connection if strands are bent, or otherwise damaged.

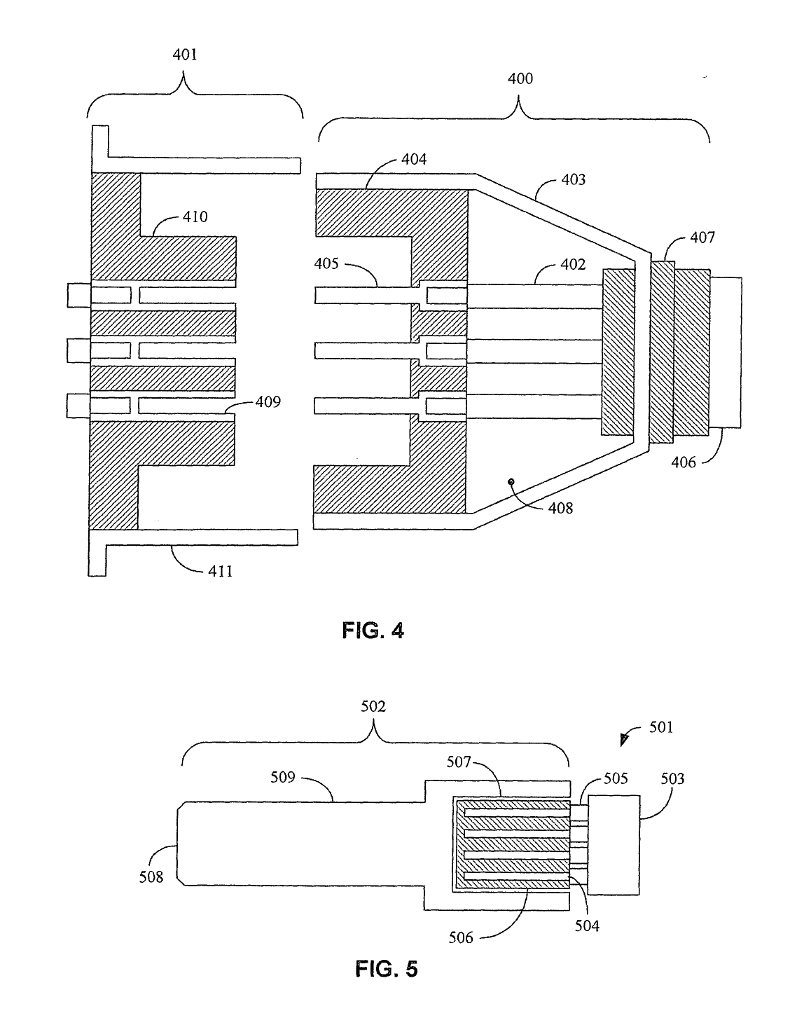

FIG. 4 is an illustration of a male connector portion or plug 400 at an end of a wiring harness, and a corresponding female connector portion or socket 401 at a wireless power transfer device in accordance with an exemplary embodiment of the present invention. The wiring harness comprises six litz wire cables 402, three of which are shown in FIG. 4. The plug 400 comprises a housing 403, an insert 404, and pins 405 received by the insert 404. The cables 402 are protected by a sheath 406 before entering the housing 403 via a gland 407. The cables 402 may each be connected to the respective pins 405 in a manner illustrated by FIG. 5.

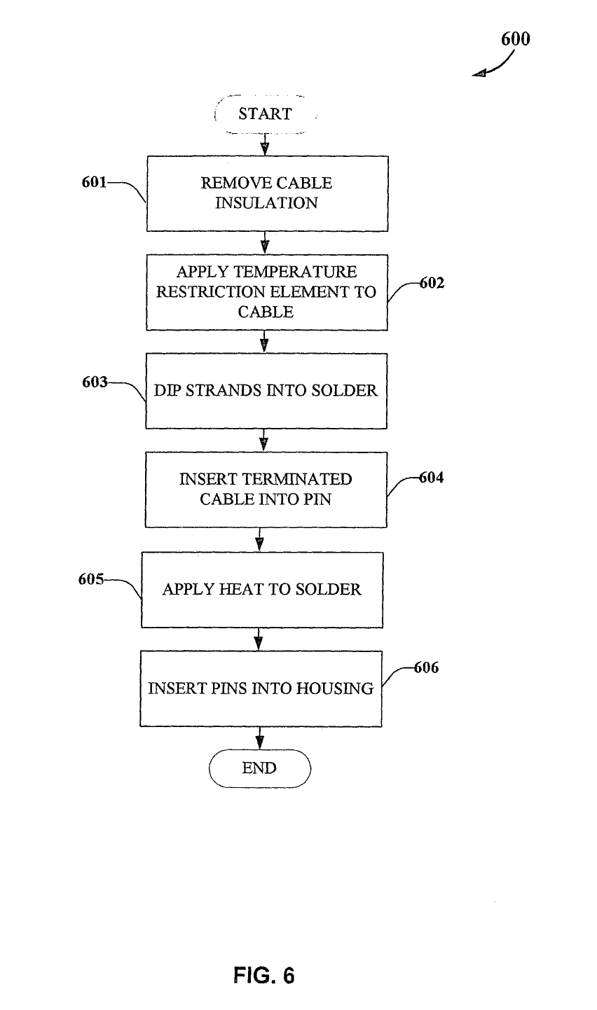

FIG. 5 provides an illustration of the connection of a litz wire cable 501 to a pin 502. FIG. 6 is a flowchart for an exemplary methodology 600 of manufacturing a wiring harness, such as that illustrated in FIG. 4. Reference will be made to FIGS. 3, 4, and 5 in the process of describing the methodology 600.

In step 601, the insulation 503 of the cable 501 is removed, exposing the individual strands 504 coated in enamel 505. In step 603 the cable 501 is terminated by simultaneously dipping the strands 504 into a solder pot (not illustrated) containing solder heated to substantially four hundred and fifty degrees Celsius which strips the enamel coating 505 from each strand 504 and causes solder 506 to permeate through the gaps between strands 504 in order to electrically interconnect them. It should be appreciated that the temperature of the solder may vary depending on the material characteristics of the enamel coating, but is anticipated to be within the range of 350 to 500 degrees Celsius.

In one embodiment a temperature restricting element, for example a damp cloth, may be applied to the cable at step 602 prior to dipping the strands in the solder at step 603. By cooling the cable, heat transfer from the solder pot to the cable insulation 503 and enamel coating 505 may be limited, minimizing the extent that these are melted and fused.

The pin 502 includes recessed end for receiving the soldered end of the cable 501, in the form of a cylindrical receptacle 507 into which the terminated cable 501 is inserted at step 604. Heat is then applied to the strands 504 or receptacle 507 at step 605, causing the solder to melt and create a continuous connective path between the strands 504 and pin 502.

The pin 502 includes a male portion 508 having a cylindrical contact surface 509 substantially four millimeters in diameter. This circular exterior surface serves to reduce the effects of eddy currents and proximity effects caused by the AC signal passing through the cables. At high frequencies, for example 20 kHz, the skin depth in copper is 0.46 millimeters. A pin with a wide circumference may enable high levels of current to be passed through the cable at such frequencies. The cylindrical contact surface also maximizes the degree of connection between the male portion 508 and a corresponding female portion of a pin of a corresponding connector portion of a wireless power transfer device (not illustrated). This maximized connection allows for greater efficiency in the passage of electrical current through the connector. In one embodiment the pin 502 is also made of a highly conductive material such as copper, although this is not intended to be limiting. In one embodiment each pin 502 and cable 501 can be rated to approximately 23 Å(rms) at 830V(rms), where the impedance of the device to which the wiring harness is connected is approximately 12 ohms. It should be appreciated that these ratings have been provided by example only.

In one embodiment, it may be desirable to use a pin produced by Harting™ having the part number 09 32 000 6108 intended for use in a DC application. Generally, any pin having the properties discussed above may be suitable for use in the high frequency, high current environment of the present invention. It should be appreciated that the pin of the wiring harness side portion of the connector is not limited to having a male portion, and that the configuration may be reversed, or a combination.

Returning to FIG. 4, at step 606 each pin 405 is received by the insert 404, which holds them in place relative to the housing 403. The housing 403 has a space 408 between the insert 404 and the gland 407. In the process of terminating the litz wire cables 402, the heat causes the enamel coating on the individual strands to melt along a short length of the cable 402, creating a stiff section. The strands within this stiff section are more brittle, and thus more susceptible to damage if the cable 402 is bent. Containing the stiff section within the housing 403 prevents or at least alleviates bending of the stiff section of the cable at or adjacent the pins 405 while maneuvering the wiring harness during installation, or minute bending over time which may be caused by vibrations for example.

The socket 401 is mounted to a wireless power transfer device, or electrical device to be used in a wireless power transfer system, and comprises female pins 409 configured to receive the male pins 405 of the plug 400. The female pins 409 are received by a second insert 410, which is in turn mounted within a socket housing 411.

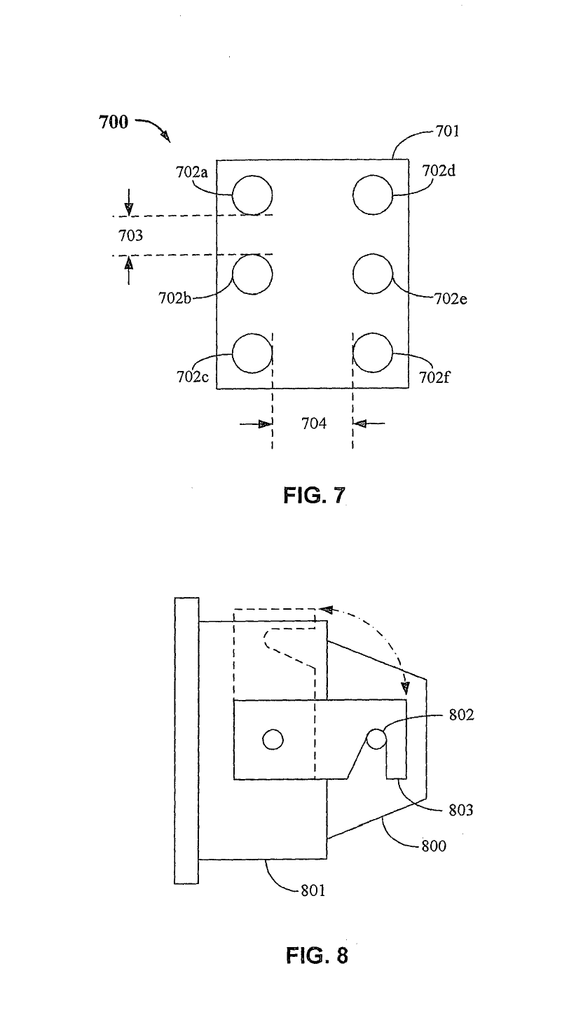

FIG. 7 illustrates a face on view of an insert 700 for use in a connector portion, whether a plug or socket such as illustrated in FIG. 4, in accordance with an exemplary embodiment of the present invention. The insert 700 comprises a body 701 having six apertures 702a-f, which are each configured to receive a pin (not illustrated) terminating a cable (not illustrated).

A wireless power transfer system may include paired cables, with one cable designated as an outgoing cable, and the other as a returning cable. It is desirable to maximize the voltage isolation between outgoing and returning cables. In order to do so while minimizing the physical size of the connector, the apertures 702a-f are split into two sets: outgoing apertures 702a-c, and incoming apertures 702d-f. The distance 703 between apertures within a set is less that the distance 704 between the sets.

Further, the body 701 of the insert 700 does not include any material between the sets of apertures which may create a conductive loop. This is to reduce energy losses due to the induction of eddy currents between outgoing and incoming cables. This also applies to other components of the connectors. In one embodiment the body 701 is made of a plastic, but this is not intended to be limiting and may be made of any suitable material.

FIG. 8 illustrates an exterior view of a connected plug 800 and socket 801, the components of which may be similar to those illustrated by FIG. 4, in accordance with an exemplary embodiment of the present invention. The plug 800 includes a protrusion 802 onto which a latch 803 mounted on the socket 801 catches to fasten the plug 800 and socket 801 together. The environment in which the wireless power transfer system is installed—for example on a vehicle or in an area to be driven over by vehicles—may be highly susceptible to impact or vibrations which may cause a connection reliant on friction to become disconnected. The mechanical fastener provided for by the protrusion and latch gives an additional degree of connection to minimize the likelihood of this occurring. It should be appreciated that other fasteners may be used to fasten the plug 800 and socket 801, and that the latch mechanism illustrated is not intended to be limiting.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality may be implemented in varying ways for each particular application, but such implementation decisions should not be interpreted as causing a departure from the scope of the embodiments of the invention.

The various illustrative blocks, modules, and circuits described in connection with the embodiments disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be a processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art. A storage medium is coupled to the processor such that the processor can read information from, and write information to, the storage medium. In the alternative, the storage medium may be integral to the processor. Disk and disc, as used herein, includes compact disc (CD), laser disc, optical disc, digital versatile disc (DVD), floppy disk and blu ray disc where disks usually reproduce data magnetically, while discs reproduce data optically with lasers. Combinations of the above should also be included within the scope of computer readable media. The processor and the storage medium may reside in an ASIC. The ASIC may reside in a user terminal. In the alternative, the processor and the storage medium may reside as discrete components in a user terminal.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

Various modifications of the above described embodiments will be readily apparent, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

Unless the context clearly requires otherwise, throughout the description and claims, the terms “including”, “comprising” and the like are to be construed in an inclusive sense, as opposed to an exclusive or exhaustive sense. That is to say, in the sense of “including, but not limited to.”

Any discussion of the prior art throughout the specification should in no way be considered as an admission that such prior art is widely known or forms part of the common general knowledge in the field.

1. A wireless power transfer system comprising:
a wireless power transfer device, comprising a first connector portion;
an electrical device comprising a second connector portion; and
a wiring harness comprising:
a cable;
a first end connector portion at one end of the cable, the first end connector portion being configured to be removably connected to the first connector portion; and
a second end connector portion at the other end of the cable, configured to be removably connected to the second connector portion.

2. The wireless power transfer system of claim 1, wherein the electrical device comprises a battery charging system.

3. The wireless power transfer system of claim 1, wherein the electrical device comprises a power supply.

4. A wiring harness for a wireless power transfer system, comprising:
a plurality of cables, each comprising a plurality of conductive filaments; and
a first connector portion connected to a first end of the cables, the first connector portion comprising a plurality of pins each comprising a recessed end,
wherein an end of each of the cables is soldered into the respective recessed ends.

5. The wiring harness of claim 4, wherein each cable comprises litz wire.

6. The wiring harness of claim 4, wherein each pin is rated for at least 23 A (rms).

7. The wiring harness of claim 4, wherein each pin is rated for at least 830V(rms).

8. The wiring harness of claim 4, wherein each pin is made of copper.

9. The wiring harness of claim 4, wherein each pin comprises a cylindrical contact surface.

10. The wiring harness of claim 9, wherein the cylindrical contact surface is at least substantially 4 mm in diameter.

11. The wiring harness of claim 4, wherein at least two of the cables have a first designation and at least two of the cables have a second designation, and wherein the first connector portion is configured to receive the pins such that the voltage isolation between the cables of the first designation and the second designation is greater than that between the cables of the same designation.

12. The wiring harness of claim 4, wherein the first connector portion is configured to have no conductive loops between the pins.

13. The wiring harness of claim 4, wherein the first connector portion comprises a housing which alleviates bending of the cables at or adjacent the pins.

14. The wiring harness of claim 13, wherein the housing comprises means for fastening the first connector portion in a socket.

15. A method of manufacturing a wiring harness for a wireless power transfer system, comprising:
for a plurality of cables each comprising a plurality of conductive filaments, soldering the respective conductive filaments together to form a plurality of terminated cables;
inserting each terminated cable into a respective recessed end of a pin of a first connector portion; and
applying heat to each terminated cable such that the conductive filaments are soldered to the pins.

16. The method of claim 15, wherein terminating each cable comprises inserting the conductive filaments of the cable simultaneously into a solder pot.

17. The method of claim 16, wherein the temperature of the solder pot is maintained within a range of substantially 350 degrees Celsius to substantially 450 degrees Celsius.

18. The method of claim 17, wherein the temperature of the solder pot is maintained at substantially 450 degrees Celsius.

19. The method of claim 15, further comprising inserting the pins into a housing which prevents bending of the cables at or adjacent the pins.
